(19) United States
(12) Patent Application Publication
(10) Pub. No.: US 2012/0151771 A1
(43) Pub. Date: Jun. 21, 2012

(54) METHOD FOR ADJUSTING AN AXIAL BIASING FORCE OF A SHAFT IN A TRANSMISSION

(76) Inventors: Rainer Kueck, Cologne (DE); Torsten Voigt, Cologne-widdersdorf (DE)

(21) Appl. No.: 13/407,674

(22) Filed: Feb. 28, 2012

Related U.S. Application Data
(63) Continuation of application No. 12/281,978, filed on Sep. 5, 2008.

(30) Foreign Application Priority Data
Mar. 29, 2006 (DE) 10 2006 014 790.1

(51) Int. Cl. B23P 11/00

(52) U.S. Cl. 29/898.06

(57) ABSTRACT

A method for adjusting an axial biasing force of a shaft in a transmission is described that involves manufacturing a variety of shims of different lengths by bending wires into rings that are not closed along their circumference. Shims are selected from the variety of shims of different lengths dependent and inserted between the first tapered roller bearing and a housing wall of the transmission for adjusting a manufacturing biasing force. By heating the assembled transmission to an operating temperature, the biasing force is decreased below the manufacturing biasing force or becomes zero. This accomplishes a minimal friction and therefore a smooth synchronization while still avoiding play during operation.

### CROSS-REFERENCE TO RELATED APPLICATIONS

This application is a Continuation Application of U.S. Ser. No. 12/281,978 that was a national phase of the International Patent Application PCT/EP2007/002619 filed on Mar. 24, 2007 that claims the priority from the German patent application 10 2006 014 790.1 dated Mar. 29, 2006. The publications of all aforementioned applications are herewith incorporated by reference.

### BACKGROUND OF THE INVENTION

The invention relates to a gearbox, comprising a housing, with at least one shaft mounted in the housing such as to rotatable and with at least one shim, by means of which the axial play and an axial biasing of the shaft in the housing or between components arranged on the shaft may be adjusted, said shim comprising a wire bent into the shape of a ring.

For example in the WO 01/02749 an automotive gear shift transmission is disclosed, having two input shafts and two output shafts. One output shaft is supported in the housing of the gear shift transmission in a rotatable manner by means of two tapered roller bearings. For providing that the tapered roller bearings can bear forces in an optimized manner in radial as well as in axial direction, the shaft should be supported by means of the tapered roller bearings at the housing in axial direction in a play-free manner and at the same time, for avoiding unnecessary friction, should be supported substantially free of bias.

In a gear shift transmissions having a shaft made of steel and a housing that is for instance made of aluminum, the shaft with the tapered roller bearings provided thereon may be biased in the cold state in axial direction in relation to the housing. When the transmission heats up to the operating temperature, this results in decreasing the bias.

It is known to use shims for adjusting the axial play or axial bias, said shims being inserted in axial direction between the housing and one of the two tapered roller bearings. In series manufacturing, an assortment of shims of various thicknesses is kept in stock for being able to accommodate manufacturing tolerances so that for the assembled transmissions the same amount of bias or the same amount of axial play can be provided.

Such shims are punched out from a sheet metal and are thereafter machined by grinding for achieving a high accuracy of the shim thickness. However, punching out from sheet metal results in high waste of material.

### SUMMARY OF THE INVENTION

Therefore, it is an object of the invention to design a transmission such that adjusting of the axial play or an axial bias of the shaft in the transmission can be achieved in a simple and low-cost manner.

According to an aspect of the invention a method for adjusting an axial biasing force of a shaft in a transmission is provided, said transmission comprising a housing made of aluminum; at least one shaft made of steel mounted in the housing such as to be rotatable, a first tapered roller bearing and a second tapered roller bearing supporting the shaft in the housing between a first housing wall and a second housing wall such that the shaft and consequently the first and second roller bearings are biased at least in the cold state of the transmission; and one single shim by means of which the axial biasing force of the shaft in the housing may be adjusted; said method comprising: manufacturing a variety of shims of different lengths by bending wires into rings that are not closed along their circumference; determining the distance between the first housing wall and the second housing wall; selecting a specific shim of a specific length from the variety of shims of different lengths dependent on the determined distance between the first housing wall and the second housing wall; inserting the shim between the first tapered roller bearing and the first housing wall supporting this first tapered roller bearing at a manufacturing temperature of the aluminum housing and the steel shaft for establishing a manufacturing biasing force; and decreasing the biasing force to an operating biasing force that is lower than the manufacturing biasing force or becomes zero by raising the temperature of the aluminum housing and the steel shaft to an operating temperature that is higher than the manufacturing temperature.

### DETAILED DESCRIPTION OF THE INVENTION

Preferably, the ring may have a rectangular cross section. A rectangular cross section of the ring results from the bending of the wire if the cross section of the wire comprises the shape of a trapeze prior to bending. The trapeze comprises a shorter and a longer edge that are parallel with respect to each other and are connected by two obliquely extending edges. By bending into a round shape the lengths of the shorter edge and the longer edge become even due to the compressive and tensile forces so that bending into a round shape results in a rectangular or substantially rectangular cross section of the ring.

According to a preferred embodiment the ring is not closed along its circumference. This results in that two ends of the wire oppose each other without being connected. After bending into a ring the wire only has to be cut to the desired length. This keeps the manufacturing simple, without compromising the function of the shim, namely adjusting an axial play or an axial bias.

The wire can be manufactured by warm roll forming or cold roll forming. This allows for instance to form a wire having a round cross section into a wire having a trapezoid cross section. During the roll forming process the wire can be drawn, allowing to reduce its cross section accordingly.

The ring can be pressed to its intended size. This means that pressing process provides the wire that had been bent into a round shape with the desired thickness that is crucial for its function. In the alternative or in addition one axial side face of the ring can be ground. By means of this grinding process the shims can be provided with very good tolerances.

Preferably, the biasing force is decreased to zero by raising the temperature of the aluminum housing and the steel shaft to the operating temperature so that the shaft with the bearings is positioned free of play and free of axial biasing force in the housing.

It is pointed out that locking rings or Seeger circlip rings that are used for fixing a position of a component in axial direction on a shaft or axle are bent from a round wire. Such locking rings are usually engaging the groove wherein, however, the exact thickness of the locking ring does not matter. According to the invention, a wire bent into a ring shape is not used for securing a position, but for adjusting the axial play or the axial bias of a shaft in a transmission. This allows adjusting the axial play of a shaft between two opposing walls of the transmission or between a wall and another, coaxially disposed shaft or any other rotatable component. Further, such a ring allows to adjust the axial play or bias between components held on the shaft.

### BRIEF DESCRIPTION OF THE DRAWINGS

The invention will be illustrated in the following by referring to the embodiments shown in the figures. These show in:

FIG. 1 schematic components of a transmission according to the invention; and in

FIG. 2 cross sections of a wire that is used as a shim.

### DETAILED DESCRIPTION OF THE DRAWINGS

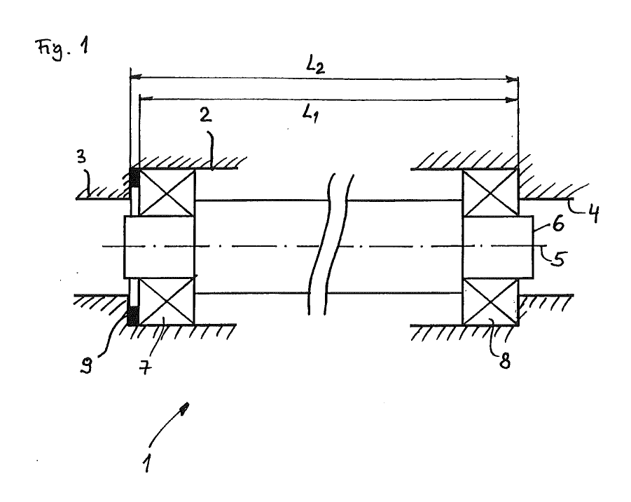

FIG. 1 shows schematically components of a transmission that is denoted in its entirety with reference numeral 1. The transmission 1 comprises a housing 2, said housing comprising a housing wall 3 and a housing wall 4. A shaft 6 is supported in a rotatable manner in the housing 2, rotatable around a rotational axis 5. Supporting the shaft 6 is achieved by a first bearing 7 and a second bearing 8. The first bearing 7 and the second bearing 8 are preferably designed as tapered bearings, for instance tapered roller bearings.

The shaft 6 may comprise an input shaft, an output shaft or an intermediate shaft of the transmission 1. The shaft may comprise several loose wheels, fixed wheels, intermediate wheels and/or gear shift clutches that are, however, not shown in FIG. 1.

By means of a shim 9 the axial play or the axial bias of the shaft 6 in axial direction is adjusted precisely. The shim 9 is located between the housing wall 3 and the first bearing 7. By means of the shim 9 the difference in length L2 compared to a length L1 is compensated. The length L1 is the axial assembly size of the shaft 6 with the bearings 7, 8. The length L2 is defined by the geometry of the housing 2. Due to manufacturing tolerances the differences in the length between L2 and L1 may vary, so that for adjusting an axial play or an axial bias during the series manufacturing a variety of shims 9 of different lengths will be used. An axial bias of the shaft 6 can for instance be useful if the housing 2 is made from aluminum, and the shaft 6 is made from steel, wherein the bias is defined by the transmission 1 in its cold state. When the transmission 1 achieves during operation its operating temperature, due to the difference in the coefficient of thermal expansion the length L2 changes more than the length L1 with the consequence that the bias that had been adjusted by the shim 9 decreases and in many cases ideally reaches the value zero, so that the shaft 6 with the bearings 7, 8 is positioned free of play and free of bias in the housing 2.

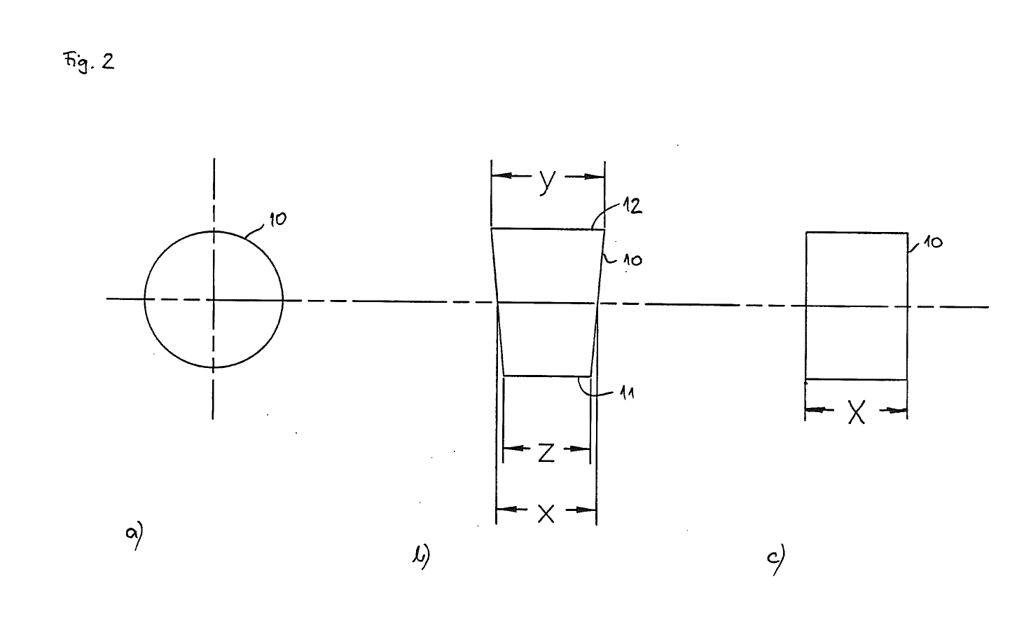

FIG. 2 shows a cross section of a wire 10 that can be used for manufacturing the shim 9 according to FIG. 1. The wire 10 is a thin, elongated piece of metal that can be bent into a ring.

FIG. 2a shows a wire 10 with a circular cross section. By means of a rolling process the circular cross section according to FIG. 2a can be formed into a trapezoid cross section as shown in FIG. 2b. During this rolling process, the wire 10 is preferably drawn, so that the cross sectional area of the trapezoid wire according to FIG. 2b is smaller than the cross sectional area of the circular cross section according to FIG. 2a.

The medium measure X of the trapezoid cross section represents the subsequent thickness of the shim 9. The thicknesses Z and Y representing the lengths of the shorter edge 11 and the longer edge 12, respectively, depend on the diameter of the ring that is formed by a bending process of the wire according to FIG. 2b. By bending into a round shape the compressive and tensile stresses created thereby within the material approximate the measures Z and Y to the measure X. This creates a ring with a rectangular cross section as shown in FIG. 2c. The width of the cross section is then X.

During the rolling of the wire 10, at least one of the measures X, Y, Z can be measured and controlled. For achieving a different measure X, the rolling machine used for the rolling process does not have to be reconfigured, but only the transverse rollers have to be readjusted.

After bending of the wire 10 into a ring the wire can be cut accordingly. Grinding is typically no longer necessary. Therefore, also no burr that may result in a change of the axial length may be formed during a grinding process. Also, there is no risk of injury caused by a burr during the manual assembly.

### LIST OF REFERENCE NUMERALS

1 transmission

2 housing

3 housing wall

4 housing wall

5 axis

6 shaft

7 first bearing

8 second bearing

9 shim

10 wire

11 short edge

12 long edge

X thickness

Y thickness

Z thickness

L1 length

L2 length

1. A method for adjusting an axial biasing force of a shaft in a transmission, said transmission comprising a housing made of aluminum; at least one shaft made of steel mounted in the housing such as to be rotatable, a first tapered roller bearing and a second tapered roller bearing supporting the shaft in the housing between a first housing wall and a second housing wall such that the shaft and consequently the first and second roller bearings are biased at least in the cold state of the transmission; and one single shim by means of which the axial biasing force of the shaft in the housing may be adjusted; said method comprising:
manufacturing a variety of shims of different lengths by bending wires into rings that are not closed along their circumference;
determining the distance between the first housing wall and the second housing wall;
selecting a specific shim of a specific length from the variety of shims of different lengths dependent on the determined distance between the first housing wall and the second housing wall;
inserting the shim between the first tapered roller bearing and the first housing wall supporting this first tapered roller bearing at a manufacturing temperature of the aluminum housing and the steel shaft for establishing a manufacturing biasing force; and
decreasing the biasing force to an operating biasing force that is lower than the manufacturing biasing force or becomes zero by raising the temperature of the aluminum housing and the steel shaft to an operating temperature that is higher than the manufacturing temperature.

2. The method according to claim 1, further comprising rolling the wire such that it assumes a trapezoid cross section prior to bending the wire into a ring.

3. The method according to claim 2, further comprising drawing the wire during the rolling process.

4. The method according to claim 1, further comprising pressing the wire into its intended size after the wire had been bent.

5. The method according to claim 4, further comprising grinding the wire on one side after the wire had been bent and pressed.

6. The method according to claim 1, further comprising grinding the wire on one side after the wire had been bent.

7. The method according to claim 1, wherein the biasing force is decreased to zero by raising the temperature of the aluminum housing and the steel shaft to the operating temperature so that the shaft with the bearings is positioned free of play and free of axial biasing force in the housing.
